(19) United States
(12) Patent Application Publication
(10) Pub. No.: US 2018/0057263 A1
(43) Pub. Date: Mar. 1, 2018

(54) Rail-bound transport robot for picking goods in a storage rack, and method for the operation therof

(71) Applicant: Servus Intralogistics GmbH, Dornbirn (AT)

(72) Inventor: Christian BEER, Schwarzach (AT)

(21) Appl. No.: 15/638,751

(22) Filed: Jun. 30, 2017

(30) Foreign Application Priority Data
Jun. 30, 2016 (DE) 10 2016 008 078.7

(51) Int. Cl. B65G 1/137; B65G 1/04; B25J 15/06

(52) U.S. Cl. CPC B65G 1/137; B25J 15/0616; B65G 1/0492

(57) ABSTRACT

A method for operating a transport robot (1) in a storage rack (27) having at least one horizontal rack travel path (33-34), to which is assigned at least one storage level (35, 35a-35c) on which a plurality of objects are stored in the form of packages and/or cardboard boxes (59, 61) and/or pallets (60) and/or individual packaging units (25, 25a-25c), wherein the transport robot (1) has at least one working plane (53) on which is mounted at least one destination container (6, 6a), wherein the same can be loaded with the different objects (25, 59, 60, 61) by means of a loading means (8, 40, 44, 46) on the robot, in the manner of a pick and place process, wherein
a.) in a first method step, the transport robot (1) is brought into a position in the storage rack opposite the object (25, 59, 60, 61) being picked, in front of a marking (62) fixed to the object,
b.) in a second method step, the object (25, 59, 60, 61) being picked is drawn to the working plane (53) of the transport robot (1) by means of a first loading means (44) on the robot, and
c.) in a third method step, the object (25, 59, 60, 61) stored in the working plane (53) is separated into the destination container (6, 6a) by means of the second loading means (22, 46, 47, 48, 50, 51) on the robot.

The invention relates to a rail-bound transport robot for picking goods in a picking in a storage rack, according to the preamble of claim 1.

The term “picking” is used to mean the collection of certain subsets (articles) of a total available amount (the inventory) from a storage rack, based on orders therefor. This can be a customer order or a production order. The automatic device which collects the order is referred to as the picker, retriever, or gripper. The act of picking is comparable to the retrieval of specified articles to create an order consisting of one or more order items, and indicating the quantity of each individual item.

The subsets consist of items which are collected from the inventory (the total quantity in the storage rack) for an order (the request data).

The picking constitutes the transition from the single-item storage to the mixed order, and includes the following basic functions:
providing the goods
moving the picker
removing the goods
delivering the goods

The following picking technique types are known:
Multi-order picking: Several orders are processed at the same time by one picker.
Pick and Pack System: The items are picked and packaged directly into the shipping box. A volume calculation based on the order and the articles is required in this case to determine which shipping carton will be used.

[Source: Martin, Heinrich: Transport- und Lager ogistik, 9th Ed., Springer 2014, Page 396 ff.]

A transport robot with a loading means as the picker is known from WO 2016 014 917 A1 for example. In this known use, the loading means is a non-rail-bound transport robot, with a multi-axis robot placed on the chassis thereof as a loading means, the same having a suction arm or suction gripper with which it is able to remove objects from a storage device, and load the same.

For this purpose, the transport robot according to WO 2016 014917 A1 carries a destination container along, and is able to reach into various shelf levels of a picking rack with its suction gripper, grip an article or an object deposited there, and convey the same into the container it carries along with it.

After the separating function is complete (fulfillment of the picking task), the transport robot travels out of the storage rack with the loaded destination container and unloads the destination container at a picking station.

As such, the transport robot cannot perform any picking tasks in the storage rack. It is therefore not suitable for “rearranging” the objects or packaging units in the storage. For example, it cannot consolidate an object A from storage location X1, Y1, Z1 with an object B from storage location X2, Y2, Z2, and place both objects A+B at a third storage location X3, Y3, Z3 in a controlled manner in order to later reliably find this collectivity again and combine the same with other objects, or transport the same out of the storage.

The camera technology used in this case is expensive, does not operate reliably, and does not allow reliable localization (retrieval) of a collectivity once stored in the storage rack. Specifically, it requires a reliable pattern recognition of all objects, which relies on intensive software usage and long turnover times.

Due to the size of the multi-axis robot, only a maximum of three shelf levels can be serviced, since the height of the multi-axis robot is limited. It is not possible to arrange a multi-axis robot with a height of, for example, 6 meters on this type of free-moving transport robot, with the aim of improving the grasping height, because this leads to weight and balance problems during operation. Grasping accuracy might not be sufficient in this case.

The use of a multi-axis robot is disadvantageous with regards to the necessary costs for the construction, maintenance and control of such a multi-axis robot.

A further disadvantage is that the transport robot circulates on paths outside of the storage rack. Because of the constructed size required for this purpose, picking is only possible outside the storage rack.

It is also disadvantageous that objects arranged in the shelf plane must be recognized using an expensive camera-based process. However, the camera recognition is only used for the detection of the location of the shelf space, by means of optically detectable marks on the shelf base, and this makes it more difficult to position the transport robot, which is guided freely and relatively imprecisely, with respect to the picking rack. Therefore, it can only locate its location with respect to the storage rack, but cannot locate any individual objects.

By way of example, it is not possible to exactly position the known transport robot with respect to the picking rack, since the transport robot is freely movable in space rather than working on a rail-bound plane. The camera-based location detection therefore has to contend with three independent spatial axes (X, Y, Z).

A further disadvantage of the arrangement is that only one single transport plane (namely the floor itself) is available to the transport robot, and as such it cannot travel over a multi-story storage rack with superimposed transport planes.

As such, the conditions are lacking for better use of space in a storage rack, and for the creation of multiple storage levels, wherein the same lie outside the grasp of the multi-axis robots according to the prior art.

Because of the lack of accuracy in positioning the known transport robot with respect to the individual picking positions in the picking rack, in the cited document a user interface is additionally included on the transport robot. By means of the same, it is possible to perform local loading and unloading tasks, and optionally to make corrections, in order to retroactively teach the transport robot at a given loading and unloading station.

The removal of storage containers from the picking shelf, with the aim of loading such a storage container on the transport robot, carrying out the corresponding order picking on the same, and bringing the storage container back to the storage location, is not included in the prior art.

The known transport robot with the multi-axis robot mounted thereon is therefore dependent on the grasping height, the grasping direction, and the grasping depth in the picking rack being sufficient for it to grasp objects arranged far back in the picking rack. However, this limits the application of such a known transport robot.

In contrast, with the requirement that rear storage locations which are far from the gripper arm can be reliably detected and reached, it would be necessary to leave large vertical distances between the storage levels, resulting in poor storage density of the storage rack.

US 2016 010 19 40 A1 discloses a further storage system, likewise with a transport robot, with multi-axis robots placed on the same, which can move freely on the plane of the floor. This case exhibits the same disadvantages as the document noted above. In addition, there is the further disadvantage that objects cannot be separated. Rather, only picking boxes or parts of picking boxes with objects arranged therein can be separated.

The subject matter of WO 2012 055410 A2 discloses a further picking system, having a transport robot and a multi-axis robot, wherein the transport robot is arranged suspended vertically in the central plane of a storage system, and can be driven and moved in this location. This is a dedicated stacking arrangement, which assumes that objects of exactly the same type are piled up in a series of uniform containers.

As such, it is not possible to arrange a variety of different objects or packaging containers in a mixed configuration at different depth positions in a picking rack.

Therefore, the invention addresses the problem, proceeding from WO 2016 014 917 A1, of providing a method for picking objects directly in a storage rack.

A transport robot which carries out the method, with a loading means placed thereon, should be implemented, for picking objects directly in the storage rack, in such a manner that it allows a significantly better utilization of the storage space in the picking rack, and enables more precise functionality.

The problem is addressed by the invention being characterized by the technical teaching of claim 1.

The features of the method according to the invention are therefore that
a.) in a first method step, the transport robot is brought into a position in the storage rack opposite the object being picked, in front of a marking fixed to the object,
b.) in a second method step, the object being picked is drawn to the working plane of the transport robot by means of a first loading means on the robot, and
c.) in a third method step, the object stored in the working plane is separated into the destination container by means of the second loading means on the robot.

The advantage of feature a of the invention is that markers fixed to the object are now detected and evaluated by the transport robot, rather than just the location of the transport robot with respect to a specific position in the storage rack. This produces the advantage that it is now possible for the first time, with the simplest of means—and without the use of complex camera technology—to even identify individual objects at their deposited location in the storage rack, provided that these objects are furnished with a suitable marking which can be detected without contact.

A suitable example would be that a number of bottles are arranged on grid-like storage spaces side by side and one behind the other in the storage level of the storage rack, and are otherwise unpackaged. They are neither arranged in a cardboard box nor in any other manner of casing, and only bear a machine-readable identification—for example, on the front side thereof.

By way of example, these may be bottles which contain a liquid spice.

Using the method according to the invention, it is now possible for the first time to detect each location of each individual object in the storage rack, since the transport robot performs a contactless detection of the marking of each object, such that every object deposited on the storage level of the storage rack is individually identifiable. As such, it is possible to record and save the exact location (the location coordinates) of each individual object deposited in the storage level, and to add this to the stock register data. This means that a stock register is maintained constantly, and indicates precisely the X-Y-Z position where an individual object is deposited.

The invention according to method feature a is, of course, not limited to the piece-by-piece recording of individual objects, such as cans, bottles or similar containers. In another embodiment, it is possible to recognize complete containers instead. In this case the container—for example, a cardboard box—the pallet, or the like carries an individually identifiable, contactlessly detectable marking.

In a third embodiment, the individual objects being separated—in particular, bottles, cans, or the like—can be stored in a cardboard box, standing in a grid pattern and visible from the front side. However, the front wall of the cardboard box or other container can be at least partially removed such that each individual object can be removed through the open front wall of the cardboard box and conveyed to the working plane of the transport robot.

In this case, there is no need for an individual recognition of the object arranged in the cardboard box or container, since its location in the cardboard box or container is known because the object is located within a grid dimension in the cardboard box or container, and the type of the grid dimension is known to the controller of the transport robot.

According to feature b, it is preferred that the object is drawn to the working plane of the transport robot by means of a first loading means on the robot.

The advantage of this measure is that only one “drawing” occurs. This means that the first loading means on the robot can have a particularly simple design, since it only allows a drawing of a detected cardboard box or container from the storage rack in a horizontal plane, and no complex multi-axis robot is required—as is the case in the prior art.

A loading means on the robot, which only works in the drawing direction (the horizontal direction), results in the further advantage that it requires no grasping height in the vertical direction. This means that the loading means can be designed, in a simple embodiment, as a horizontally movable sliding-, grasping-, or bearing arm, providing the ability to travel very large load depths in the storage rack using a corresponding loading means, wherein the same can only move in the horizontal direction—possibly in a telescoping movement. It is thus possible to achieve grasping depths of up to 2 meters for the lowest load height. This is not possible with a known multi-axis robot as an attachment on a transport robot.

The third feature c enables the picking of the object drawn to the working plane of the transport robot directly on the transport robot.

The term “object” is understood in the context of the present invention to mean that single, individual objects (articles), such as bottles, cans and other containers may be referred to, or that the term “object” refers to certain additional packagings, such as boxes, pallets, containers and the like, in which a plurality of identical individual objects is arranged.

If the object being picked is then drawn to the working plane of the transport robot, it is preferred that a second loading means on the robot is provided for the picking.

This means that, according to the invention, the second loading means is designed as a picking device. This has not been known to-date.

The previous transport robots simply mounted multi-axis robots as the pick-and-place device, and this involved the disadvantages described above.

Now that, according to the invention, the second loading means is designed as a picking device, it is therefore now possible for the first time to carry out the picking itself directly in the storage rack, in the working plane of the transport robot.

This requires that at least one destination container is arranged in the working plane of the transport robot, and requires the definition of a rack location where the goods which will be picked are stored.

The picking device on the robot then performs the picking of the objects drawn to the working plane of the transport robot, automatically placing them into the at least one destination container which is likewise arranged in the working plane.

In a particularly simple and preferred embodiment, the picking device is formed as a linear X-Y-Z carriage system. As a result, no complex multi-axis robot is required. Rather, there is a simple, linear X-Y-Z system, and a separating means is arranged on the same, possibly with a rotating drive. Such a separating means can be a suction gripper, or a mechanical or electromagnetic or magnetic gripper.

It can also be a separating means which is capable of conveying several containers, placed in the working plane of the transport robot, open toward the top, and containing a filling which will be separated, into the destination container.

As such, in addition to individual items, the picking device according to the invention can also pick bulk materials, by means of the transport robot, directly in the storage rack.

As such, the decisive feature of the technical teaching according to the invention is that the transport robot can carry out automatic picking tasks in a storage rack with high storage density and high filling factor. It can, so to speak, be sent into the storage rack with a picking order, where it carries out the tasks automatically, without having to leave the storage rack in the process. It can, so to speak, “rearrange” the storage when given a corresponding picking order. It does not require any further control or further control functions because it is completely autonomous, and the picking orders received via a radio interface are carried out in sequence automatically.

Of course, the invention is not limited to a single transport robot with a picking function. In a further implementation, a plurality of independently operating (autonomous) transport robots with picking functions operate on the same or on different storage levels of a storage rack. It is particularly advantageous that each transport robot autonomously executes its picking order saved in its central control unit, and in the process does not rely on the receipt of further control instructions during the picking work in the rack. In order to avoid collisions with further picking robots simultaneously operating on the same level, the picking robots may exchange data with each other, including the path of travel, travel time, picking time, picking order, and other parameters.

In another embodiment of the invention, a multi-axis robot is used as the picking device, although the above-mentioned design of the picking device as an X-Y-Z carriage system is preferred.

In contrast to the prior art, the transport robot is now on rails, and carries at least one destination container on its chassis.

At least one loading means is arranged on the chassis. It is assigned to a multi-story picking rack, which specifically has at least one lifting tower on the input side. The same is able to convey the rail-bound transport robot along different rack travel paths in the picking rack.

The technical teaching provided here leads to the advantage that the transport robot, with the attached loading means, is suitable for the automatic, rapid picking of goods in a multi-story picking rack, since it can be conveyed by means of at least one lifting tower, arranged on the input side, to different rack travel paths arranged vertically above each other and parallel to each other.

As such, it is able to travel several different rack travel paths in a multi-story picking rack, which are arranged vertically one above the other and/or next to each other. A plurality of rack levels where objects are stored can be accessed in each rack travel path. As a result, it is possible to pick objects in the tightest spaces in such a storage rack.

A recognition system with no camera is described above as a preferred embodiment. However, in another embodiment, a system with a connected camera can also be used. Every position of the object deposited in the storage level can be detected with a three-dimensional camera system. When the multistory picking rack is filled, each storage location is determined and noted by the transport robot working fully automatically, such that a unique and repeatable loading and unloading position is assigned to each stored object, either via the camera recognition or the article-based marking.

This loading and unloading position can be accessed with the utmost precision. This is because, for the first time, as a result of the rail-bound transport robot, the advantage is achieved that, regardless of unevenness in the travel path—as is the case for transport robots traveling on the floor—precise localizing of the transport robot, in relation to each object arranged at a defined loading and unloading position, is ensured.

Such an object may be very small. The object may be an individual object the size of a jam jar or even smaller, or individual parts such as, for example, drills, cutters, chisel tools or the like, arranged separately from each other in suitable plastic packaging in the shelf, and therefore also accessible separately from each other. As stated above, in the absence of a camera-based recognition, each object can be configured with an electronic and/or optically recognizable marking to enable precise localization by the transport robot.

A high storage density is achieved by the multi-story storage rack, since the individual storage levels can be arranged tightly one above the other. This is because, in principle, they only need to be spaced sufficiently apart from each other in the vertical direction that the deposited objects do not collide with the storage level above.

A high storage density is thus achieved; and the transport robot, with its attached loading means which moves exclusively horizontally, can grasp very deeply into the storage level.

The first loading means can have a suction gripper on its free end, driven parallel to the storage level and able to move into the same.

In another embodiment, the first loading means can be designed as a simple, horizontally movable loading arm, wherein the suction gripper is then driven and movable via a second loading means to move over the storage level of the transport robot and to be lowered into the same.

In both cases, the first loading means, which is driven only in the horizontal direction for pushing and pulling, can overcome storage depths of up to a depth of 1000 mm. Up to ten rows of objects can be arranged in a horizontal plane one behind the other at such a depth.

This results in an optimum utilization of the storage levels of a storage rack, with maximum precision in the identification of the location of each deposited object.

According to a further feature of the present invention, which should be subject to protection independently of the aforementioned features, the transport robot with the attached loading means is designed in such a manner that the transport robot is able to take a storage container out of the specific storage level of the storage rack, load the same on its chassis, remove the objects contained in the storage container by means of the loading means, and place the same into the destination container likewise placed on the chassis of the transport robot.

According to this embodiment of the invention, this results in the advantage that bulk material can also be present in the storage container which is taken by the first loading means and is drawn onto the chassis of the transport robot. By way of example, these bulk goods can be loose material, such as granules, plastic parts, electrical components and the like which can be dumped out.

As such, it is now possible for the first time that the second loading means picks up the loose material by means of its suction mouthpiece, and delivers it, in the same plane, to the destination container arranged adjacently on the chassis of the transport robot.

As such, in addition to the separation and picking of individual separate objects, it is also possible to pick bulk materials. This was not possible in the prior art.

A further advantage of the invention is that very high storage density can now be achieved, due to the possibility of removing individual storage containers arranged in the storage level of the storage rack, because it is no longer necessary for the transport robot, with its suction gripper, to be moved into the rearmost plane of the storage rack. This is because it can remove the storage container from the level in the storage rack, pull it onto its chassis, and can separate the objects arranged in the storage container into the destination container, which is likewise arranged on the chassis.

In a further development of the invention, the second loading means arranged on the chassis of the transport robot makes it possible to independently move a rail-like gripping- and/or pulling- and/or transport tool into the picking rack, to grasp the container positioned there, and to draw the same onto the transport robot. As such, there is no longer a need for a multi-axis robot, which takes up a great deal of vertical space, to complete these loading and unloading functions. Rather, the loading means arranged on the chassis of the transport robot performs these loading and unloading functions for the storage container arranged in the picking rack.

This results in the advantage of yet another reduction in the storage height, since the distance between the individual storage levels only needs to be large enough to correspond to the height of a storage container.

The latter possibility—the arrangement of a separate loading means on the transport robot—is primarily preferred for heavy storage containers, with a weight exceeding, for example, 35 kg.

A relatively small, space-saving multi-axis robot which is arranged on the transport robot according to the invention, would not be able to perform loading and unloading tasks with such heavy load containers. For this reason, a separate loading and unloading means is provided on the transport robot.

Such a loading and unloading means can consist of two mutually parallel, telescopically driven rails which reach into the storage level when in the extended telescopic position, grasp the container laterally or from beneath, and then pull it out.

It can also be a conveyor belt driven to move in a direction transverse to the direction of travel of the transport robot, wherein the conveyor belt travels into the storage level.

In another embodiment, the loading and unloading means can consist of gripping- or suction tongs which are arranged on the transport robot in a manner allowing telescoping, and which are able to pull out the storage container positioned on the storage level and place it on the surface of the transport robot, and to convey it back to the storage level once picking is complete.

The subject matter of the present invention results not only from the subject matter of the individual patent claims, but also from the combination of the individual patent claims.

All information and features disclosed in the documents, including the abstract—in particular, the spatial configuration shown in the drawings—are claimed as essential to the invention insofar as they are novel, individually or in combination, over the prior art.

Insofar as individual objects are referred to as “essential to the invention” or “important”, this does not mean that these objects necessarily have to form the subject matter of an independent claim. This is determined solely by the wording of each independent claim.

In the drawings:

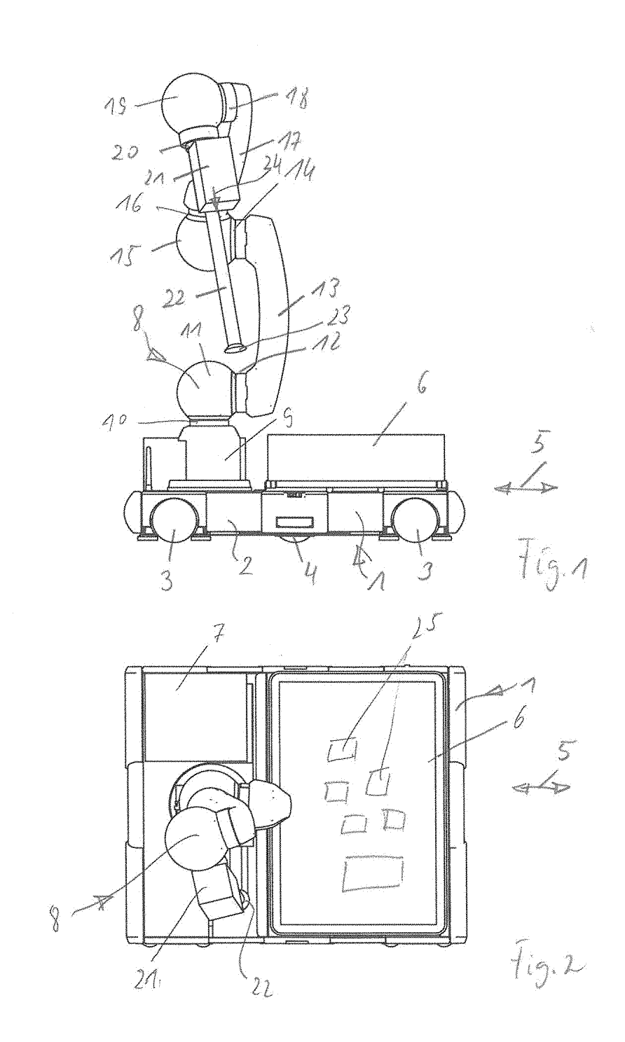

FIG. 1 shows a side view of a transport robot in its moving position,

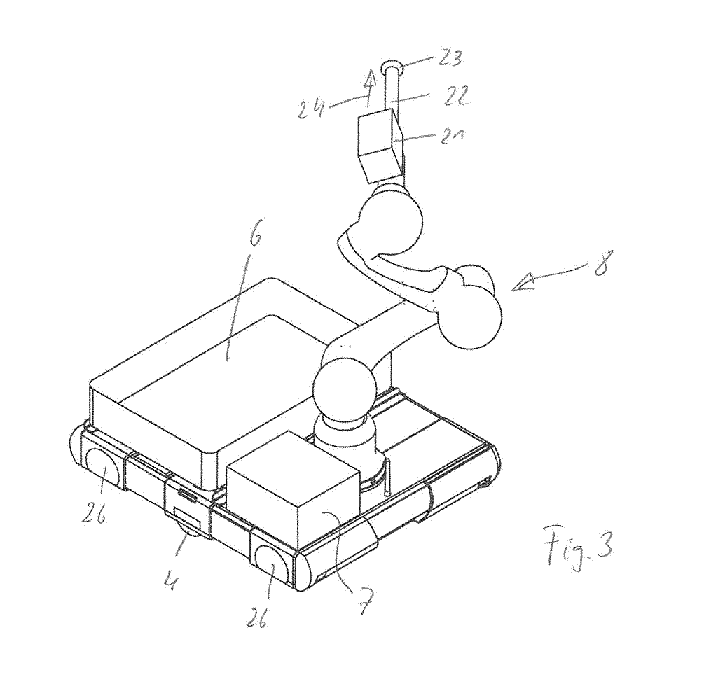

FIG. 2 shows a top view of FIG. 1,

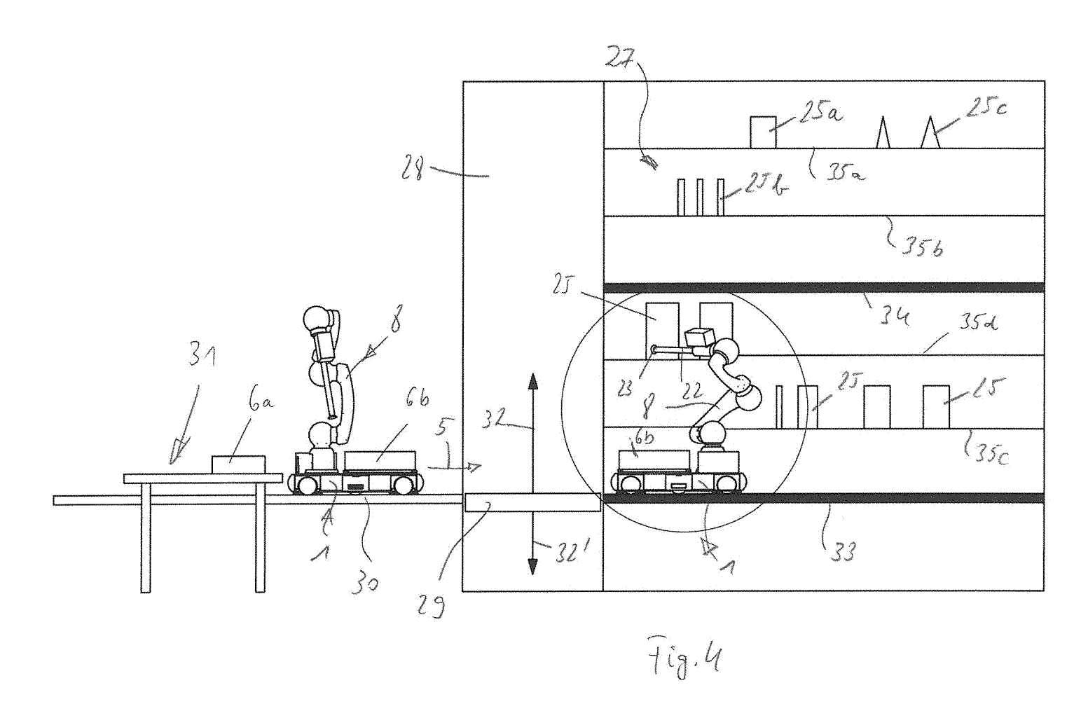

FIG. 3 shows a perspective view of FIGS. 1 and 2,

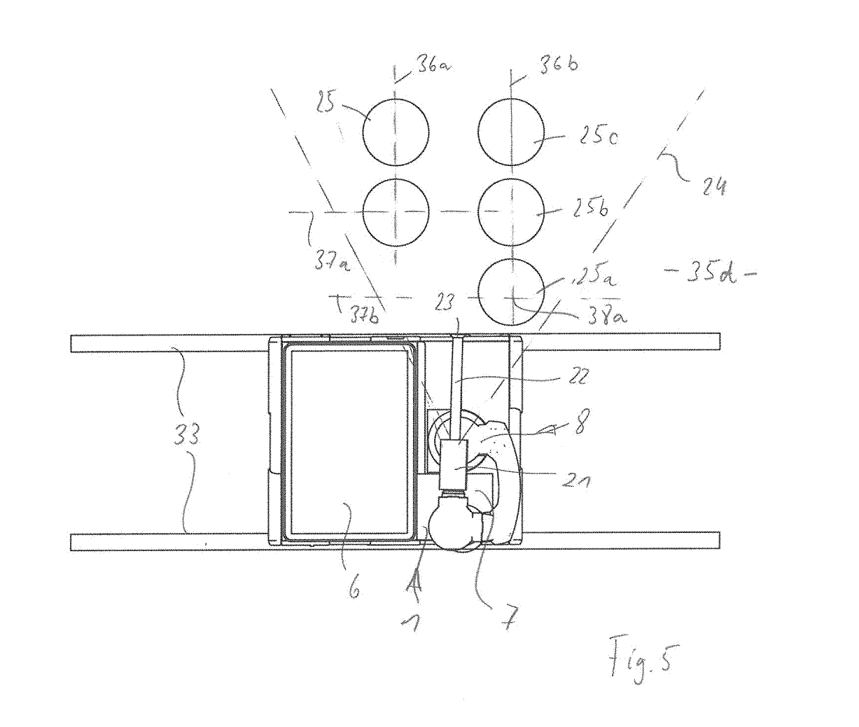

FIG. 4 shows a side view of a storage rack, showing two different operating positions of the transport robot,

FIG. 5 shows the top view of the transport robot during the object recognition in the storage rack,

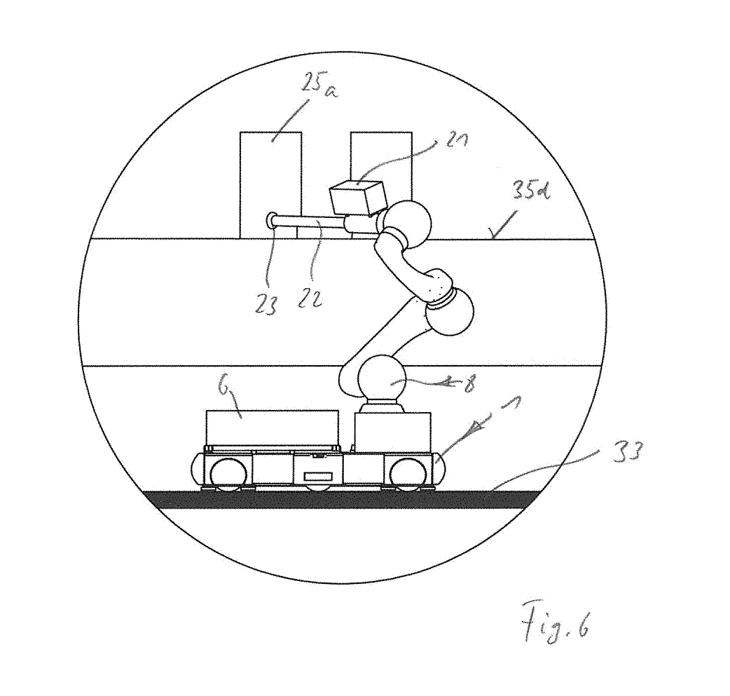

FIG. 6 shows a side view of FIG. 5,

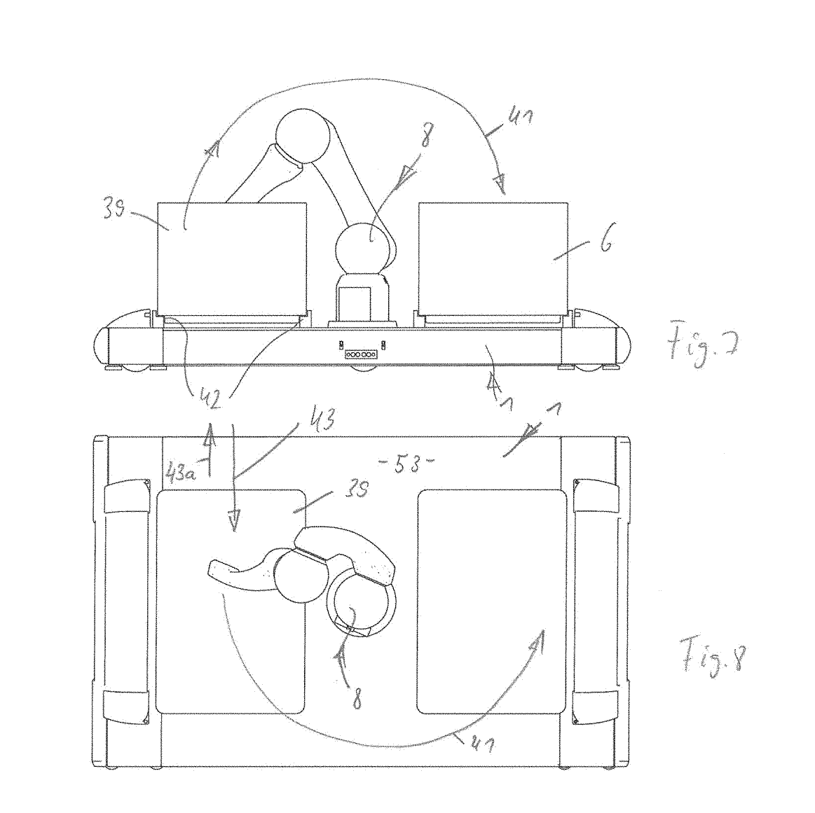

FIG. 7 shows a side view of an embodiment in which the multi-axis robot performs the picking,

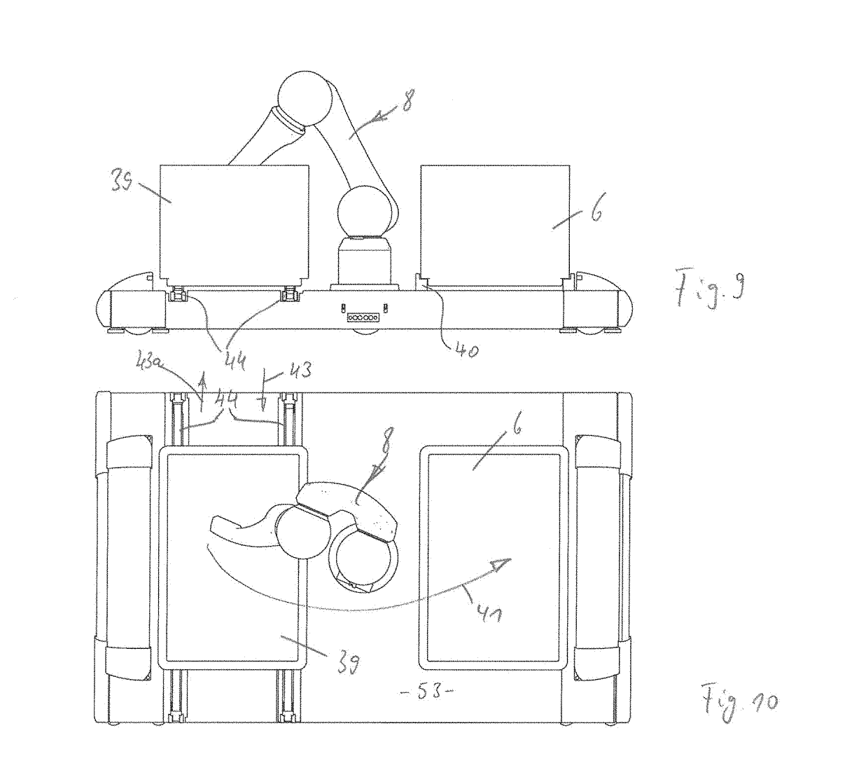

FIG. 8 shows a top view of FIG. 7,

FIG. 9 shows a side view of an embodiment modified from FIG. 7,

FIG. 10 shows a top view of FIG. 9,

FIG. 11 shows a transport robot with a mounted picking device, in a front view,

FIG. 12 shows the transport robot with the picking device in a perspective view, in a first method state,

FIG. 13 shows the transport robot of FIG. 12, in a front view, during the picking in the storage rack,

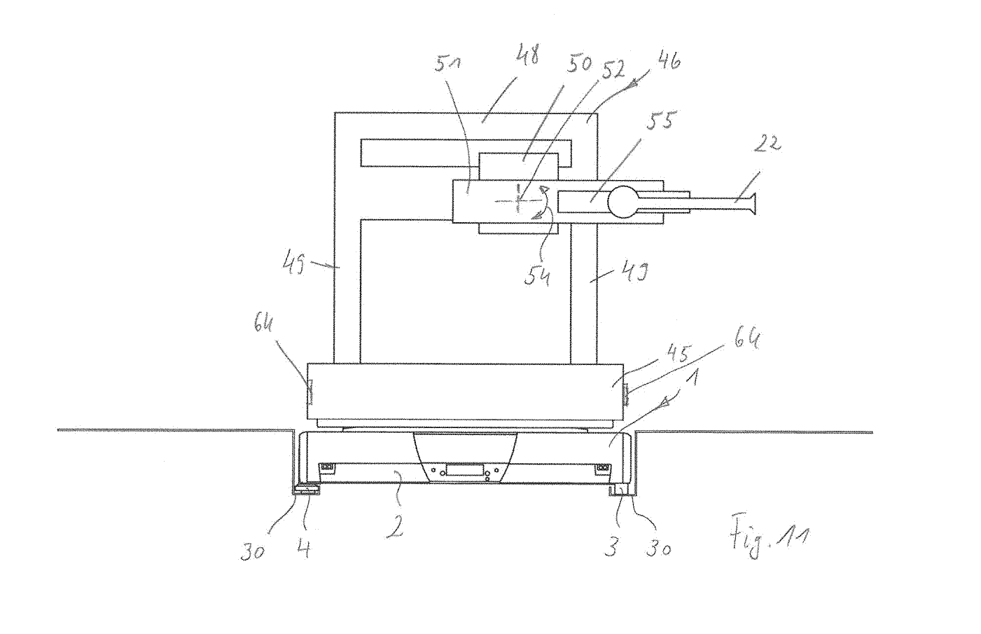

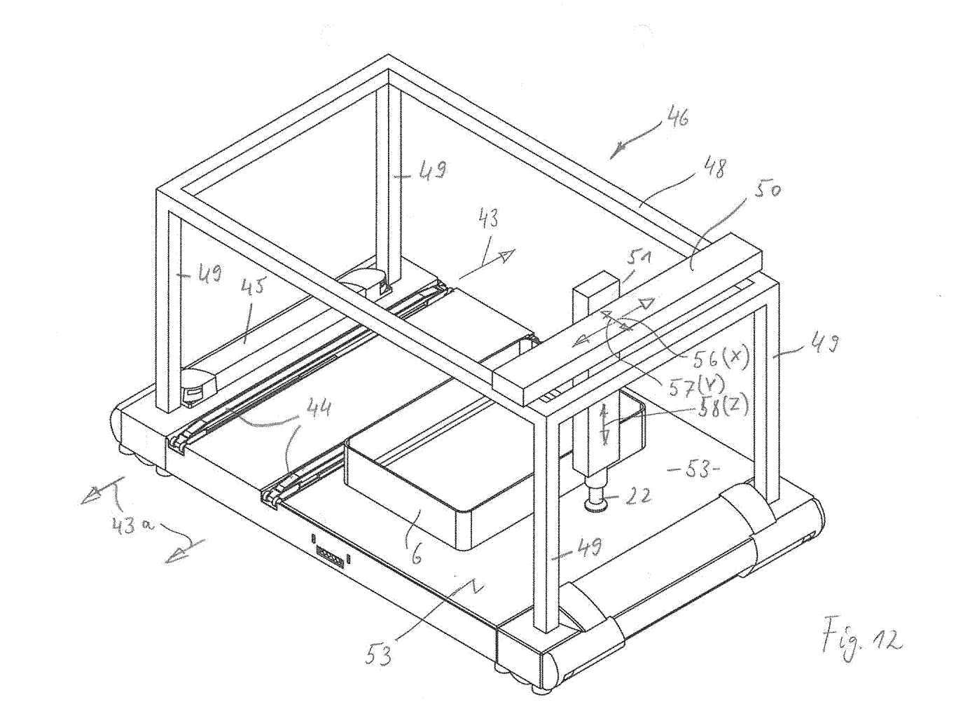

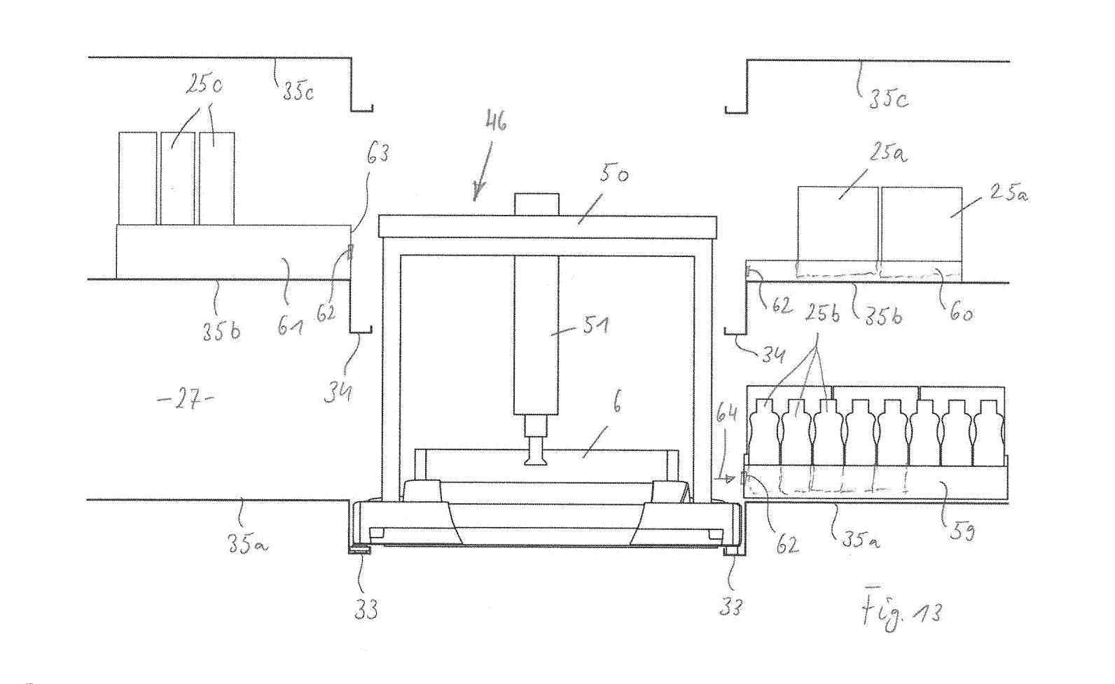

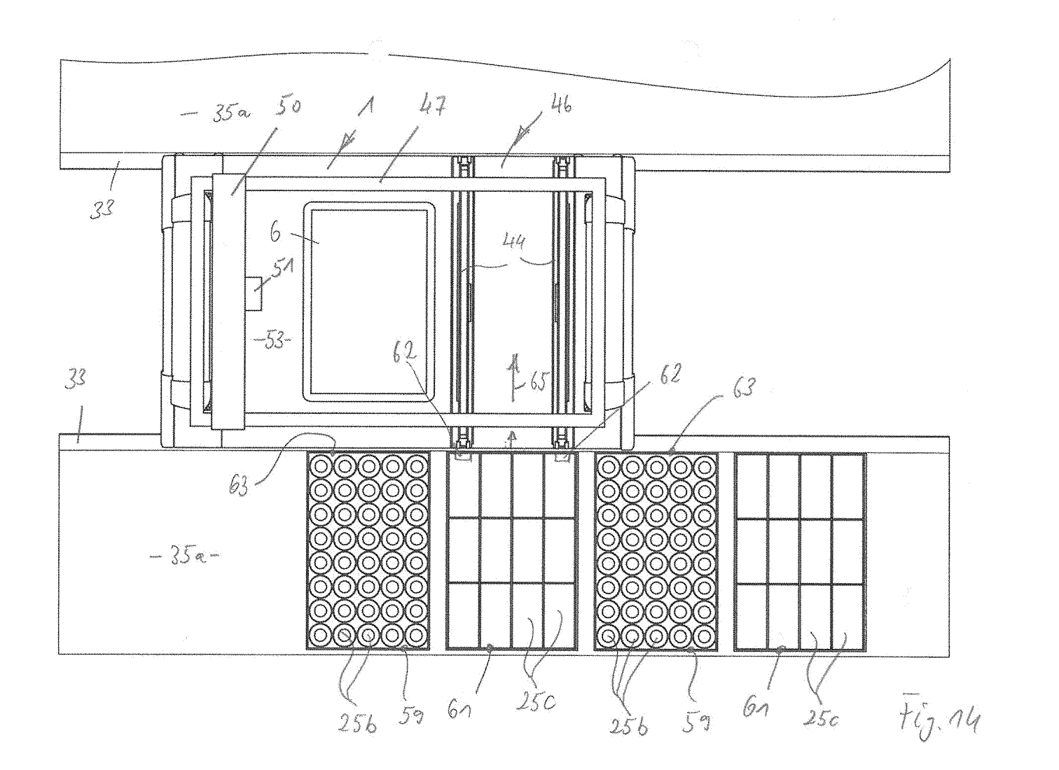

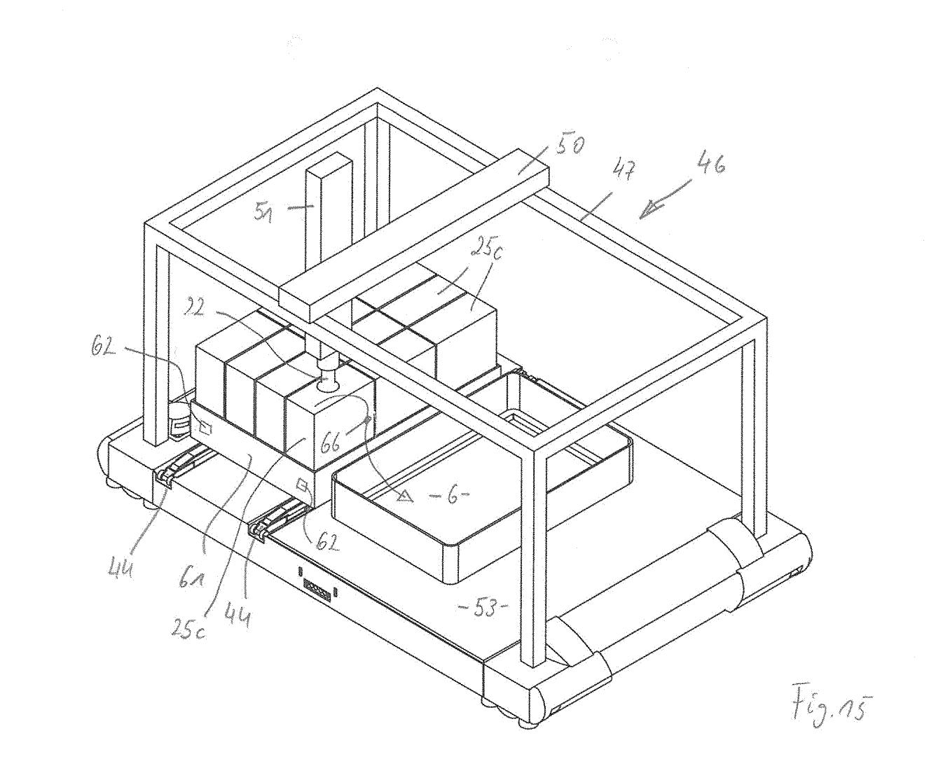

FIG. 14 shows the transport robot according to FIG. 13, in a top view,

FIG. 15 shows a perspective view of the transport robot in a second method state, in comparison to FIG. 12,

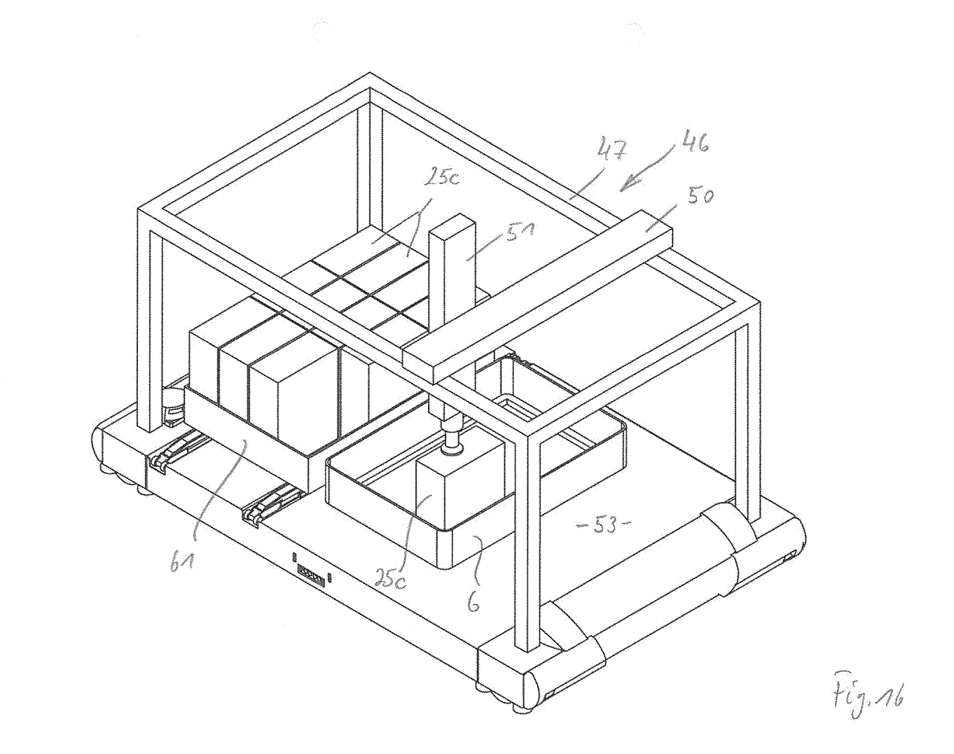

FIG. 16 shows the transport robot according to FIG. 15, in a third method state,

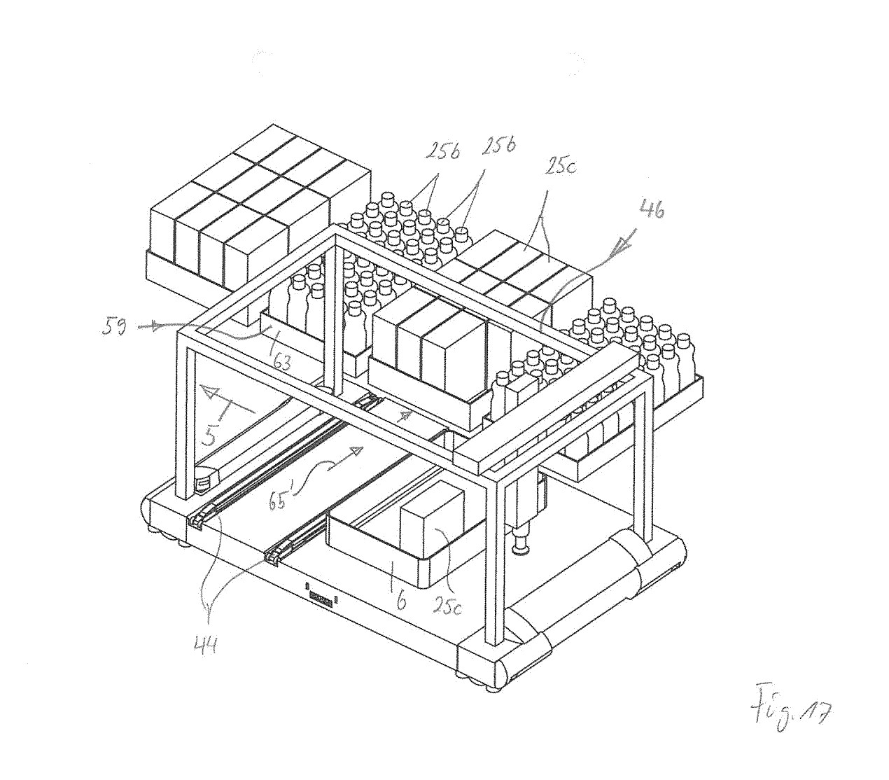

FIG. 17 shows the transport robot according to FIG. 16, in a third method state,

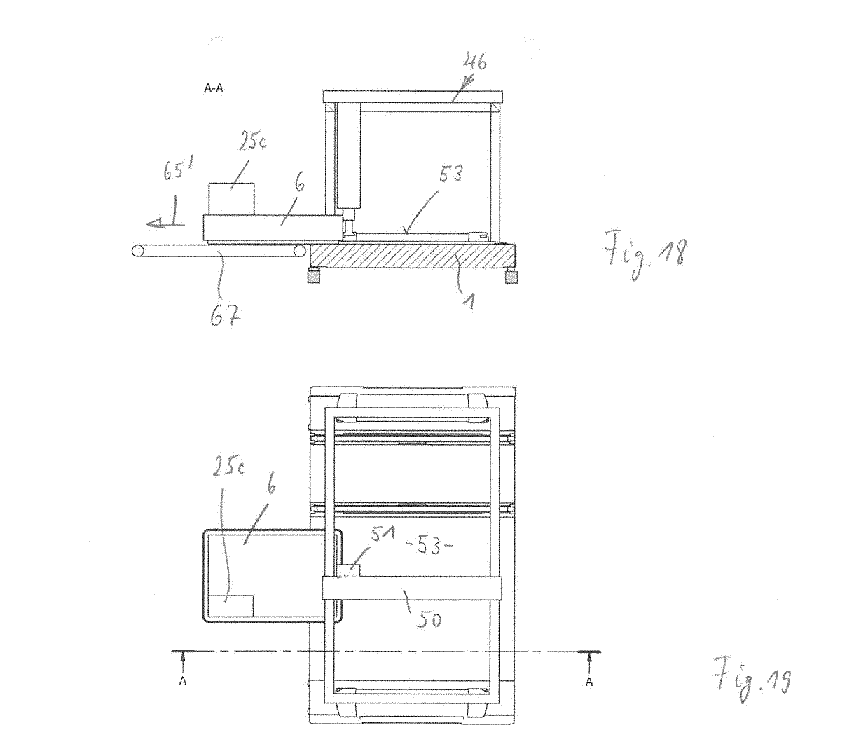

FIG. 18 shows the transport robot according to FIG. 17, in a front view, and

FIG. 19 shows the transport robot according to FIG. 18, in a top view.

FIGS. 1 to 3 provide a general illustration of a transport robot 1 according to the invention, which substantially consists of a chassis 2, with synchronously driven drive wheels 3 on one side thereof, whereas only covers 26 (see FIG. 3) and a measuring wheel 4 scanning the travel path are arranged on the opposite side.

The measuring wheel 4 is arranged approximately centrally on the side with the covers 26 (see FIG. 3), and is adapted to sense the travel path of the transport robot 1 on the rail, depending on distance, and to communicate the same over a radio interface (for example, according to the ZigBee standard) to a central computer system (not illustrated).

ZigBee is a specification for wireless networks with low data traffic, such as in home automation, sensor networks, lighting technology, etc. The focus of ZigBee is short-range networks (10 to 100 meters). However, ranges of several kilometers are also possible.

The entire transport robot 1 is able to move autonomously, in accordance with the patent applications (for example, DE 10 2007 005 029 B1 or DE 10 2005 012 561 A1) of the same inventor, only named by way of example, is controlled by a central control system, and receives only movement tasks from the central control system, which it then perform independently using its autonomous intelligence.

Accordingly, it is able to move independently on a rail system in the arrow directions 5. At least one first destination container 6, suitable for holding different packaging units 25, is arranged on its chassis 2.

At least one multi-axis robot 8 is arranged on the chassis 2, made of various slewing rings, producing a preferably six-axis robot overall. However, the invention is not limited to this feature. Instead of a six-axis robot, any other multi-axis robot can be used.

It is also possible to use so-called scalar-type robots, which work in a different manner than the multi-axis robot shown here. There may also be a combination of a scalar-type robot with a multi-axis robot, wherein the scalar-type robot performs the stocking (loading and unloading of goods) in the rack as the first loading and unloading, due to its precise functionality, and then “feeds” the multi-axis robot carried along with the scalar-type robot, as a second loading and unloading means, which in turn performs the picking onto the transport robot.

As for the multi-axis robot 8, a stand 9 is attached on the chassis 2 of the transport robot 1, and transitions via a first slewing ring 10 into a first connecting link 11.

The first connecting link 11 transitions into a connecting link 12 constructed in the direction perpendicular to the first slewing ring 10, with a further connecting link 13 connected thereto. The latter transitions into a further slewing ring 14 arranged at an angle of 90 degrees thereto, which leads into a further connecting link 15. This transitions into a slewing ring 16 which leads into a connecting link 17, and a slewing ring 18 is arranged on the connecting link 17 and has a rotary connection to the connecting link 19.

A further slewing ring 20 is arranged on the connecting link 19, with a camera system 21 arranged on the free end thereof. This enables a viewing direction 24 in the direction of the suction gripper 22 rotatably arranged on the slewing ring 20.

A suction mouth 23 is arranged on the front end of the suction gripper 22, and is designed as a possibly telescopic tube distinguished by a collar-like rubber cap.

In this way, a suction-gripping action can be ensured even in the event of oblique placement of the suction mouth 23 on an object.

A vacuum unit 7 is arranged on the chassis 2 to create a vacuum in the suction gripper 22.

Of course, according to the invention, other gripping systems can be used rather than a suction gripper 22—in particular, mechanical gripping systems which work with the electromagnetic tongs or with other mechanical, electrical or electromagnetic gripping systems.

FIGS. 2 and 3 show the transport robot according to the invention, with the attached multi-axis robot 8, in different views. In FIG. 4, a first application is illustrated.

An input and output path is arranged in front of a storage rack 27, formed as a picking rack, in the manner of a travel path 30, which according to FIG. 5 consists of rails spaced apart from each other, on which the transport robot 1 moves freely in the arrow directions 5 and in the opposite direction thereto.

Outside of the storage rack 27, the travel path 30 includes a delivery point 31 where individual destination containers 6, 6a are deposited and held.

In the illustrated embodiment, the transport robot 1 has loaded a destination container 6b, and moves with the same in the direction of arrow 5 over the travel path 30 on the input side, into a lifting tower 28, which substantially consists of a lifting platform 29 which can be driven to move in the direction of arrows 32, 32′. As such, it can be conveyed by the lifting platform 29 to different rack travel paths 33, 34 in the storage rack 27.

The lifting tower 28 can also be arranged on both the input and output side of the storage rack 27.

In the illustrated embodiment, the transport robot 1 moves to the lower rack travel path 33 and is thus able to service at least two, or more than two, superimposed storage levels 35c, 35d.

The same is true for the upper rack travel path 34, which offers access to the storage levels 35a, 35b.

The embodiment shown here merely shows two superimposed storage levels 35. The invention is not restricted to this illustration. A plurality of further storage levels can also be arranged one above the other, wherein the small distance between the storage levels 35 is characteristic for the invention.

On each storage level 35d, 35c, individual packaging units are deposited in a precisely defined position, spaced apart from each other. As such, there is no need to deposit packing boxes or storage bins. Rather, the objects themselves can be deposited, which greatly speeds up the throughput of the storage.

As such, storage containers as in the first embodiment according to FIGS. 1 to 5 can be entirely dispensed with, which ensures easier handling.

In the embodiment shown according to FIGS. 4 and 5, therefore, the transport robot 1 is moved in the storage rack 27 to the position shown in FIG. 5. For the collection of packaging units 25a-25c arranged individually in the storage level 35d, in a first embodiment of the invention, a camera system 21 is operated, the same detecting three-dimensionally all the packaging units 25 reachable at this location, with the view angle 24, and also determining their distance and depth. The evaluation is performed in a digital program of the pattern recognition, the results of which are communicated via the radio interface to the control computer of the transport robot.

In this way, an automatic image recognition detects, by way of example, that the front packaging unit 25a is arranged in the intersection of the two position lines 36d, 37b, and the packaging unit 25b is arranged in the plane behind it—specifically, at the intersection of the position line 37a and the position line 36b.

In this way, the storage location 38 has already been determined by means of the camera system and the automatic position detection in the transport robot when the storage level 35d was filled, and will not be changed again. As such, the fact that the packaging unit 25a is precisely located at the storage location 38a has been determined in a repeatable manner, and the other packaging containers at the storage locations 38b and 38c can be precisely localized in a repeatable manner.

Due to the fact that the transport robot is rail-bound in the rack travel path 33, a high repeatability precision of the position detection of the individual storage locations 38a-c is thus ensured. This is not possible, with this precision, with transport robots which move freely on the floor. The repeatability precision is in the range of <2 mm.

FIG. 6 shows, in comparison to FIG. 4, a section in which the same objects are provided with the same reference numerals. FIG. 6 shows that the suction pad 23 of the suction gripper 22 is now placed on a packaging unit 25a, which is then subsequently conveyed by means of the multi-axis robot 8 into the destination container.

FIGS. 7 to 10 show a further embodiment of the invention, intended to receive separate protection from the previous embodiment, and/or in combination with the aforementioned embodiments.

In contrast to the aforementioned embodiment according to FIGS. 1 to 6, FIGS. 7 to 10 show that the transport robot 1 also has the ability to pull out a storage container 39 from the storage level 35 of the storage rack 27 in each of the specific storage locations 38a-c, and draw the same onto its chassis 2.

The storage container drawn onto the chassis 2 of the transport robot 1 is held in a precise position using lateral guide means 42. These lateral guide means 42 can be lateral stop strips or friction-reducing slide- or roller guides.

At this point, it is possible to remove the objects stored in the storage container 39 drawn onto the transport robot 1, and convey them in the direction of arrow 41 (the direction of insertion) into the destination container 6, which is also arranged on the chassis of the transport robot 1.

As such, the multi-axis robot 8 carries out separation tasks in the manner of a picking process, because the objects arranged in the storage container 39 are conveyed into the destination container, wherein both containers are arranged on the chassis 2 of the transport robot 1.

It goes without saying that more than just a single storage container can be drawn onto the surface of the transport robot 1. Several storage containers can be collected, and then manipulated by the multi-axis robot 8, which then removes the individual objects from the multiple storage containers and places them into the one or more destination containers 6.

In this way, it is now possible for the first time that the transport robot 1 independently performs picking tasks in the storage rack 27, which was not the case in the prior art.

A particular advantage is that, when bulk material is arranged in the storage container 39, this bulk material can be simply conveyed in the direction of arrow 41 into the destination container in the required amount, which was previously not possible.

FIG. 8 shows that the storage container 39 can be drawn in the direction of arrow 43 (direction of removal) onto the chassis 2 of the transport robot 1, and can be pushed back in the direction of arrow 43a. These loading and unloading tasks are executed in the embodiment according to FIGS. 7 and 8 by the multi-axis robot 8.

In FIGS. 9 and 10, such loading and unloading tasks for the storage container 39 are no longer performed by the multi-axis robot 8 itself, but rather by its own first loading means 44 arranged on the chassis 2 of the transport robot 1, as already described above in the general description.

Such a first loading means consists, for example, of telescopically extendable driven rails, which are adapted to be extended to the storage level 35a-c in the storage rack, and to engage below the storage container 39, thus conveying it in the direction of arrow 43 onto the surface of the chassis 2 of the transport robot 1.

Instead of a first loading means 44, other loading means 40 can be used, wherein the same are also assigned to the destination container 6, by way of example—since in the case of very heavy storage containers, where the tensile force and the actuating force of the multi-axis robot 8 would not be sufficient, it is necessary to arrange dedicated loading means on the chassis 2 of the transport robot in order to, firstly, remove the storage container 39 in the supporting plane 35 and guide it back again, and secondly, to push the destination container 6 off of the transport robot 1 and bring it back onto the same.

Moreover, in addition to the multi-axis robot 8, a further robot can also be arranged on the chassis 2 of the transport robot 1, wherein both robots work together with a pick-and-place functionality. It is advantageous to design the robot which operates the storage rack as a scalar-type robot, which has a particularly precise guidance, as well as long reach and high access speed. The scalar-type robot which services the storage level as the first loading means then “feeds” the multi-axis robot 8, as the second loading means, with the objects 25, 39 separated out of the storage rack, which then in turn distributes the same to one or more destination containers 6, 6a on the chassis 2 of the transport robot 1.

In the aforementioned embodiments according to FIGS. 1 to 7, the multi-axis robot 8, as the first loading means, both accesses the storage level 35 in the storage rack 27, and also performs the separation tasks in the working plane 53 of the transport robot 1.

In the second embodiment according to FIGS. 9 and 10, the multi-axis robot 8, as the second loading means, only performs the picking tasks in the working plane 53 of the transport robot 1, but the loading and unloading of the transport robot with the storage container 39 is performed by a first loading means 44, which is preferably designed as horizontally movable conveyor belts which are able to travel horizontally into the storage level 35 of the storage rack 27, grasp an objected deposited there, and bring the same to the working plane 53 of the transport robot.

The advantage of the second embodiment according to FIGS. 9 and 10 was that the first loading means—specifically, the loading means which travels into the storage level 35 and takes up the storage container 39 there—has a small constructed height, such that the vertical distance between the storage levels 35a-35c can be minimized, since the multi-axis robot 8, which required greater vertical clearance, acts as the second loading means outside the storage levels 35.

The third embodiment according to the invention, which is shown in FIGS. 11 to 19, provides for the elimination of the multi-axis robot 8, instead providing a picking device 46 which is characterized by a simple X-Y carriage system, on which a second loading means is arranged, which can move in the vertical direction (the Z-direction), and which is possibly also driven to rotate.

The elimination of the multi-axis robot 8 by means of a picking device 46, which is designed substantially as a portal frame 47 with a horizontal frame 48, has the advantage of a very simple construction and a simple control, since the carriages 50, 51 are only driven for linear movement, and need not be controlled for a plurality of different axes of movement—as is required for a multi-axis robot 8.

The control complexity is therefore minimal. For this reason, a high turnover rate—as compared to a multi-axis robot—can be achieved.

The picking device 46 designed as a portal frame 47, with linearly driven carriages 50, 51, accordingly has the advantage of a simpler control, faster picking speed, and operation with lower wear.

Accordingly, FIGS. 11 to 13 show a picking device 46 which is placed on a pedestal attachment 45 on the chassis 2 of the transport robot 1, substantially consisting of a portal frame 47 which consists of an upper, peripheral horizontal frame 48 which is supported on the chassis 2 of the transport robot 1 by means of uprights 49.

On the horizontal frame 48, a first carriage 50 is slidably driven in the arrow directions 56. A further carriage 51, slidably driven in the directions of arrow 57 (the Y-direction) is arranged on the carriage 50.

On the second carriage 51, a gripping tool—in the present case constructed as a vacuum gripper 22—is slidably driven in the direction of arrow 58 (the Z-direction).

As such, it is an X-Y-Z carriage system, which, as a linear motion system, can reach any point in the X, Y and Z coordinates above the working plane 53 on the transport robot 1.

A destination container 6 is arranged in this working plane 53, and the first loading means 44 is arranged next to the destination container. It is only driven to move in the horizontal direction in the directions of arrows 43, 43a, and essentially consists of two mutually parallel and longitudinally displaceable conveyor belts which are driven between two oppositely disposed guide rollers. Accordingly, it is a continuous conveyor designed as a belt or longitudinal conveyor. It can work with rubber belts or bands.

The transport arm designed as a continuous conveyor can then, as a first loading means, be moved laterally out of the transport robot 1 in the direction of arrow 43 or in the opposite direction 43a, and thus moves into the area of the respective storage level 35, 35a, 35b, 35c.

FIG. 11 also shows that the second loading means, which in the embodiment consists of a suction gripper 22, can also be driven to be vertically displaceable along a sliding track 55, and can additionally be rotatably driven in the direction of arrows 54 about an axis of rotation 52.

This makes clear that not only the first loading means 44 is included for the loading and unloading of objects from the storage level 35, but also that the second loading means, with the suction gripper 22, can move in the storage level 35 of the storage rack 27, and optionally remove objects stored there.

The invention is therefore not limited to the arrangement of two separately controllable loading means 44, 46. In addition, according to the embodiment of FIG. 11, the loading means 44 can also be omitted, wherein only the loading means with the picking device 46, the X-Y-Z rail system, and suction gripper 22 is included.

In the following embodiments according to FIGS. 13 to 19, however, it is assumed that the two loading means 44, 46 are included and can work separately from each other.

FIG. 13 shows a first method step in the picking of objects which are arranged in a storage rack 27 on different storage levels 35a, 35b, 35c.

By way of example, a number of bottle-like objects in the form of packaging units 25b are arranged on the storage level 35a in a cardboard box 59 which encloses the packaging units 25b at least on the bottom thereof.

It is preferred that a marking 62 which can be detected without contact is placed on the front side of the cardboard box 59, and is detectable from the transport robot 1 by means of a positioning sensor 64 which works without contact.

The location detection of the cardboard box 59 in the storage level 35a can be performed by optical recognition means, or a capacitive, inductive or radio-linked (RFID) sensor means.

In the illustrated embodiment, only a first preferred embodiment can be seen—namely the localization of the cardboard box 59 via the marking 62 arranged on the cardboard box—preferably on the front side thereof.

The embodiment does not show the second embodiment specified in the general part, in which the individual objects 25b themselves carry the front-side or front-end markings 62, such that each object 25b can be detected by its location predetermined by the spacing of the cardboard box 59 in the grid pattern.

In this case, the location sensor 64 would be pointed directly at the front side of the specified object 25b being recognized, and would recognize the marking 62 arranged there. Once the spacing of the cardboard box and the objects stored therein is known, each object and its location in the cardboard box can be recognized individually.

The embodiment according to FIG. 13 also shows that different objects can be arranged on different storage levels 35a, 35b, 35c.

Individual, larger items 25a are arranged on the storage level 35a, while higher objects 25c, which can be in the form of bottles in outer packaging or as tools in outer packaging, or the like, are arranged on the opposite storage level 35b.

In the embodiment of FIG. 13, there are therefore two possibilities:

In a first embodiment, the first loading means 44 arranged on the transport robot 1 engages under the cardboard box 59 with its loading arm which can move out laterally from the transport robot 1, and draws the same onto the working plane 53 of the transport robot. This is illustrated in FIG. 14, after the first loading means 44, with its two transport arms, has moved above the cardboard box 61, and pulls the same in the direction of arrow 65 onto the working plane 53 of the transport robot 1.

The transport robot in this case is brought exactly opposite the cardboard box to be separated 61, the same holding a plurality of different objects 25c arranged in a grid-like pattern.

This action relies on one or more of the markings 62 being arranged, by way of example, on the front end of the cardboard box 61, and one or more location sensors 64 detecting these markers with millimeter-level precision, the transport robot 1 then being brought by means of its drive system precisely opposite the cardboard box 61. It is then drawn by means of the first loading means 44 onto the working plane 53 of the transport robot 1, in the direction of arrow 65.

However, as already explained with reference to the illustration in FIG. 11, it is also possible that the first loading means 44 is eliminated, and the suction gripper 52 on the X-Y-Z carriage system designed as the second loading means directly grasps the object 25c held in the cardboard box 61 on the storage level 35a, and draws the same, as an individual object, onto the working plane.

This is done particularly for the bottle-like objects 25b which are arranged in the adjacent cardboard boxes 59.

Considering the embodiment according to FIG. 14 once again, FIG. 15 shows that now the cardboard box 61 has been drawn onto the working plane 53 of the transport robot by means of the loading means 44 in the direction of arrow 65, and then the suction gripper 22 grasps a packaging unit 25c arranged in a grid-like pattern there, using a vacuum, and separates the same in the direction of arrow 66 into the destination container 6.

In this manner, any number of the packaging units 25c can be removed from the cardboard box 61, because their position in the cardboard box is precisely fixed and the position of the cardboard box 61 on the first loading means 44 is precisely defined.

As such, there is no need for camera recognition during the picking. The camera recognition is completely eliminated in this embodiment.

FIG. 16 shows the transport of the front packaging unit 25c into the destination container 6.

FIG. 17 then shows that, by means of the first loading means 44 which works horizontally using pushing and pulling, the cardboard box 61 is pushed back to the storage level 35a and deposited precisely in its location. As such, its position on the storage level 35a is precisely and repeatably determined, and the control system of the transport robot 1 now “knows” that the front, right packaging unit 25c in box 61 is gone. As such, the location of all other remaining objects in the cardboard box is known to the control system.

As the picking task continues, the transport robot 1 can be moved on its rails, in the direction of arrow 5, to a position precisely opposite the further cardboard box 59, the front wall 63 of which may be partially removed to make the bottle-like packaging units 25b contained therein accessible. In this case, there are two possibilities, as previously described:

1. The cardboard box 59 may—just as cardboard box 61—be drawn onto the working plane 53 of the transport robot 1, and separated into each bottle-like packaging unit 25b in the destination container 6, by means of the suction gripper.

2. In another embodiment, however, the suction grippers 22 of the second loading means according to FIG. 11 can move into the storage level 35a, remove such a packaging unit 25b directly from the box 59, and place it into the destination container 6.

Therefore, in addition to an individual separation of packaging units 25, a separation of packaging units arranged in containers can be performed.

FIGS. 18 and 19 show that, once the picking task is complete, the transport robot 1 can deposit its destination container 6 onto a longitudinal conveyor (depositing belt 67), where the picked destination container is discharged in the direction of arrow 65′ from the storage rack 27.

Accordingly, the invention has the advantage that a transport robot with attached picking device 46 performs picking tasks in a storage rack in a fully independent manner, without leaving the storage rack 27 or needing to complete necessary picking tasks outside of the storage rack.

Due to the space-saving design of the two loading means 40, 46, it is possible to achieve a high throughput speed at high stock density.

### LIST OF REFERENCE NUMBERS

1 transport robot

2 chassis

3 drive wheel

4 position measuring wheel

5 arrow directions

6 destination container a

7 vacuum unit

8 multi-axis robot

9 uprights

10 slewing ring

11 connecting link

12 slewing ring

13 connecting link

14 slewing ring

15 connecting link

16 slewing ring

17 connecting link

18 slewing ring

19 connecting link

20 slewing ring

21 camera system

22 suction gripper

23 suction pad

24 direction of view (21)

25 packaging units

26 cover

27 storage rack

28 lifting tower

29 hoisting platform

30 travel path

31 delivery point

32 arrow direction 32′

33 rack travel path

34 rack travel path

35 storage level a, b, c

36 position line

37 position line

38 storage location a, b, c

39 storage container

40 loading means

41 stocking direction

42 lateral guide

43 retrieval direction

43a return direction

44 loading means

45 pedestal attachment

46 picking device

47 portal frame

48 horizontal frame

49 uprights

50 carriage (X-Z)

51 carriage (Z)

52 axis of rotation

53 working plane (of 1)

54 arrow direction

55 movement path (for 22)

56 arrow direction (X)

57 arrow direction (Y)

58 arrow direction (Z)

59 cardboard box

60 palette

61 cardboard box

62 marking

63 front wall

64 location sensor

65 arrow direction 65′

66 arrow direction

67 delivery conveyor

1. A method for operating a transport robot (1) in a storage rack (27) having at least one horizontal rack travel path (33-34), to which is assigned at least one storage level (35, 35a-35c) on which a plurality of objects are stored in the form of packages and/or cardboard boxes (59, 61) and/or pallets (60) and/or individual packaging units (25, 25a-25c), wherein the transport robot (1) has at least one working plane (53) on which is mounted at least one destination container (6, 6a), wherein the same can be loaded with the different objects (25, 59, 60, 61) by means of a loading means (8, 40, 44, 46) on the robot, in the manner of a pick and place process, characterized in that
a.) in a first method step, the transport robot (1) is brought into a position in the storage rack opposite the object (25, 59, 60, 61) being picked, in front of a marking (62) fixed to the object,
b.) in a second method step, the object (25, 59, 60, 61) being picked is drawn to the working plane (53) of the transport robot (1) by means of a first loading means (44) on the robot, and
c.) in a third method step, the object (25, 59, 60, 61) stored in the working plane (53) is separated into the destination container (6, 6a) by means of the second loading means (22, 46, 47, 48, 50, 51) on the robot.

2. The method according to claim 1, characterized in that the first loading means (44) on the robot only operates in the horizontal direction, and that the second loading means (22, 46, 47, 48, 50, 51) on the robot functions as a linear carriage system in the X, Y and Z directions.

3. The method according to claim 1, characterized in that the second loading means functions as a picking device (46).

4. The method according to claim 1, characterized in that the second loading means functions as a multi-axis robot (8).

5. A transport robot (1), having at least one attached loading means (8, 46) for picking goods (25, 39) in a storage rack (27), characterized in that the transport robot (1) is rail-bound, and carries at least one destination container (6, 6a) on its chassis (2), in that at least one loading means (8, 46) which is suitable for carrying out picking tasks in the storage rack (27) is arranged on the chassis (2) of the transport robot (2), and in that at least one lifting tower (28) which conveys the transport robot (1) to different rack travel paths (33, 34) in the storage rack (27) is arranged in the storage rack (27) on the input side thereof.

6. The transport robot according to claim 5, characterized in that the transport robot (1) carries at least two different loading means (44, 46), of which one loading means (44) can only extend in the horizontal direction out of the transport robot (1) and into the storage level (35) of the storage rack (27), and in that the second loading means is designed as a picking device (46) with a carriage system (50, 51) which can move over the working plane (53) of the transport robot (1) in the X-Y-Z direction.

7. The transport robot according to claim 5, characterized in that the position and/or type of the objects (25, 59, 60, 61) being separated from the storage rack (27) is/are detected via markings (62) which are arranged on the objects and which can be detected by the transport robot (1) without contact.

8. The transport robot according to claim 5, characterized in that each position of the objects (25) deposited in the storage level (35) can be detected by means of a three-dimensional camera system (21), and in that, when the storage rack (27) is stocked, each storage location (38) is saved by the transport robot (1) and can be used to control the multi-axis robot (8).

9. The transport robot according to claim 5, characterized in that the second loading means is designed as a multi-axis robot (8) which carries a tubular suction gripper (22) as a gripping tool.

10. The transport robot according to claim 5, characterized in that the objects being separated in the form of bulk material.

11. The transport robot according to claim 5, characterized in that a scalar-type robot is designed as the first loading and unloading means (40) and carries out the loading and unloading of objects from the storage level (35) of the storage rack (27), conveying the separated objects (25, 39) to the second loading means (8, 46) for picking.

12. The transport robot according to claim 5, characterized in that the transport robot (1) has an autonomous command and control system, and only receives the movement and picking tasks from a central control computer, via a radio interface.
